(19) United States
(12) Patent Application Publication
(10) Pub. No.: US 2021/0287320 A1
(43) Pub. Date: Sep. 16, 2021

(54) CARPOOL UTILITY

(71) Applicant: Sony Corporation, Tokyo (JP)

(72) Inventors: Bibhudendu Mohapatra, San Diego, CA (US); Manavdeep Singh, Corona, CA (US)

(21) Appl. No.: 16/814,955

(22) Filed: Mar. 10, 2020

(51) Int. Cl. G06Q 50/30; G01C 21/34; B60W 60/00; H04W 4/02; G06Q 10/02

(52) U.S. Cl. CPC G06Q 50/30; G01C 21/3438; G06Q 10/02; H04W 4/023; B60W 60/00253

(57) ABSTRACT

An apparatus includes a processor configured with instructions to identify a destination of a user, access a friends list of the user, and identify a first friend in the friends list as a carpool candidate. The processor outputs on a display an indication that the first friend is a carpool candidate.

### FIELD

The application relates generally to carpool computer utilities.

### BACKGROUND

As understood herein, traffic congestion is a pervasive problem that may be alleviated in part through the use of carpools that may be granted access to priority lanes to reach destinations faster.

### SUMMARY

Accordingly, present principles provide an apparatus that includes at least one processor configured with instructions to identify a destination of a user. The instructions are executable to access a friends list of the user, and to identify at least a first friend in the friends list as a carpool candidate. The instructions also are executable to output on at least one display an indication that the first friend is a carpool candidate.

In non-limiting examples, the instructions are executable to output on the display a graphical representation of a location of the first friend, and or to output on the display a graphical representation of parking area at which a carpool can park, and/or to output on the display a selector selectable to send a message to the first friend indicating the user can pick up the first friend. The instructions may be executable to output on the display a selector selectable to cause a vehicle to drive to the parking area.

In some implementations, the instructions may be executable to identify the first friend as a carpool candidate at least in part based on a distance between the first friend and the user. In addition, or alternatively, the instructions can be executable to identify the first friend as a carpool candidate at least in part based on identifying a destination of the first friend as being within a threshold distance of the destination of the user. If desired, the instructions may be executable to, responsive to identifying the first friend, automatically cause a self-driving vehicle to divert from the destination of the user to a location associated with the first friend.

In another aspect, a method includes accessing information pertaining to candidate carpoolers, accessing information pertaining to a destination of a vehicle, and sending messages to candidate carpoolers based on the destination.

In another aspect, an assembly includes at least one vehicle and at least one processor configured with instructions to identify a destination of a user and transmit to at least a first carpool candidate a message inviting the carpool candidate to ride in the vehicle toward the destination.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates an example assembly consistent with present principles;

FIG. 2 illustrates an example vehicle consistent with present principles;

FIG. 3 illustrates an example CE device that may be used in conjunction with present principles;

FIG. 4 illustrates a block diagram of certain components of the vehicle and/or CE device shown in respective FIGS. 2 and 3;

FIG. 5 illustrates example logic in example flow chart format consistent with present principles; and

FIGS. 6-9 are screen shots of example user interfaces (UI) consistent with present principles.

### DETAILED DESCRIPTION

In overview, a carpool utility connects people such as those in vehicles stuck in traffic jams so that they can carpool to reach their destination faster and effectively decrease congestion at the same time. Consider “n” users, User1, User2 . . . User(n). Out of n users, x users, where (2<=x<=n), may be on the road at same time at GPS coordinates in a radius of few miles from each other. Assume users 1, 5 are acquaintance/friends going to the same end point. A map/traffic service/application connects them to present different options for carpool. It enables them to use carpool lanes and reach their destination faster. The map/traffic service may be connected to the users' calendars and manages their return time. It can further connect Users 1, 5 with another User who maybe a friend/acquaintance of either User 1 or 5 and can reduce congestion further while helping users to reach their destination faster. Users may drive their cars to a nearby parking location as determined by the utility or in case of driverless cars, it may drive itself to a determined parking spot.

The utility may be part of a mobile device or part of a vehicle that has real-time traffic and GPS information. The utility may have information about parking structures, users' calendars, etc. As a next step, the utility may access self-driving features of a vehicle as well.

Apart from situations of congestion, present principles can help during a trip planning. For example, if a first user is planning to go to point Z and a second user is planning to go to point Z as well, they can be alerted to this fact and so drive together. Users usually tend to look at a map service during trip planning to estimate traffic and decide an appropriate time to leave home/work. Present principles can connect the users and enable them to carpool.

This disclosure relates generally to computer ecosystems including aspects of consumer electronics (CE) device networks such as but not limited to smart glasses and smart (computerized) vehicles. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

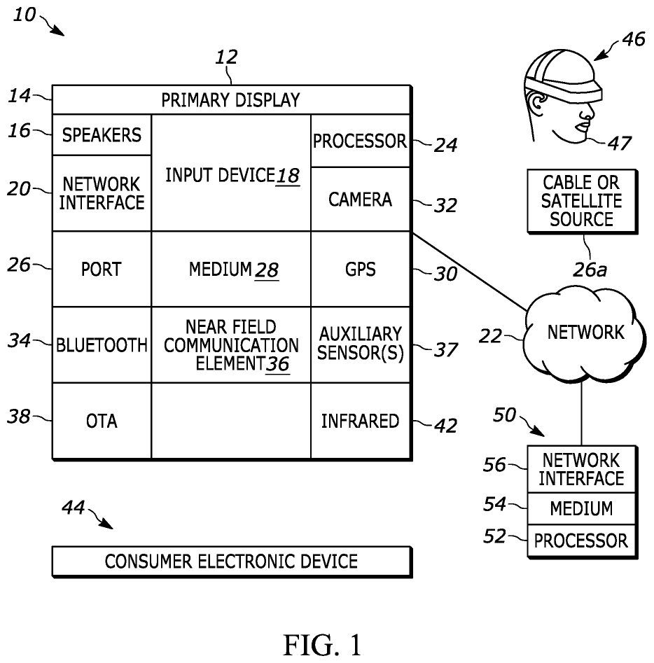

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or, the source 26a may be a game console or disk player containing content. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12.

Still referring to FIG. 1, in addition to the AVD 12, the system 10 may include one or more other CE device types. In one example, a first CE device 44 may be included in or integrated with a vehicle while a second CE device 46 may be implemented as head-mounted viewing device such as smart glasses. All devices in FIG. 1 may communicate with each other. A computerized device herein may implement some or all of the components shown for the AVD 12. Any of the components shown in the following figures may incorporate some or all of the components shown in the case of the AVD 12.

Now in reference to the afore-mentioned at least one server 50, it includes at least one server processor 52, at least one tangible computer readable storage medium 54 such as disk-based or solid state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server or an entire server “farm”, and may include and perform “cloud” functions such that the devices of the system 10 may access a “cloud” environment via the server 50 in example embodiments for, e.g., network gaming applications. Or, the server 50 may be implemented by one or more game consoles or other computers in the same room as the other devices shown in FIG. 1 or nearby.

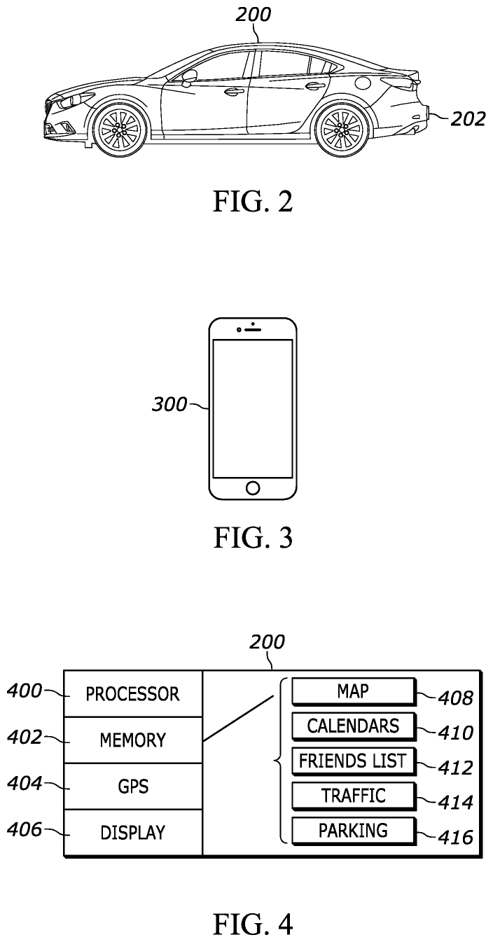

FIG. 2 illustrates a vehicle 200 that may include one or more of the components described herein to execute present principles. The vehicle 200 may include a rear and sometimes a front registration or license plate 202.

FIG. 3 illustrates a CE device 300 such as a smart phone that may be used in connection with present principles.

FIG. 4 illustrates that the vehicle 200 may include (either integrated within the vehicle or as part of a CE device being carried in the vehicle) one or more processors 400 accessing instructions and data on one or more computer memories 402. The processor 400 may receive location information from a location sensor such as a GPS sensor 404. The processor 400 may output information on one or more audible and/or visual displays 406.

The memory 402 may store map information 408 as received from a map server, calendar information 410 as received from user's mobile or other computing device, a friend's list 412 as received from a social network site, traffic information 414 as may be received from a traffic server, and parking information 416.

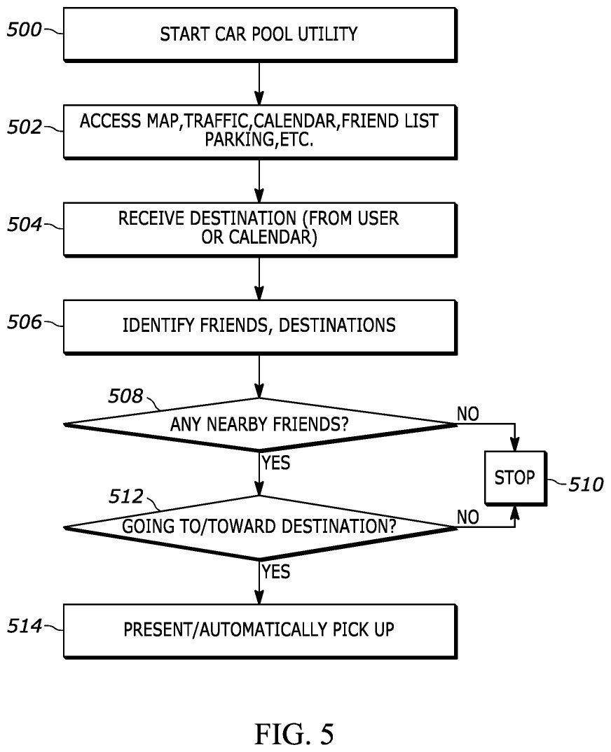

Now referring to FIG. 5, commencing at block 500 a software-implemented carpool utility is invoked on any of the processors described herein. Moving to block 502, various information may be accessed. This information may include map information from one or more map servers, traffic information from one or more traffic servers, calendar information from one or more electronic calendars of respective users, friend information from one or more social networking sites of the users, parking information map information from one or more parking servers, etc.

Proceeding to block 504, the destination of the user is received. The user may directly input a destination into the executing processor, or the processor may access automatically the user's calendar to identify a meeting or other location and correlate the location to, for example, a map coordinate.

Block 506 indicates that friends of the user and/or other candidate carpoolers are identified along with any associated destinations of the candidate carpoolers. Moving to decision diamond 508, it is determined whether any of the friends from block 506 are nearby the user's current location, e.g., are within a radius of X miles of the user. If there are no nearby friends the process may end at state 510, but if there are nearby friends the processor may determine at decision diamond 512 whether any of the nearby friends from decision diamond 508 have destinations at or near the destination of the user at times at or near an estimated time the user destination will be reached. If so, notifications may be presented at block 514 to both the user and the candidate carpoolers, and in the case of an automatically driven vehicle, the vehicle may be commanded to proceed to the location of the candidate carpooler to pick them up.

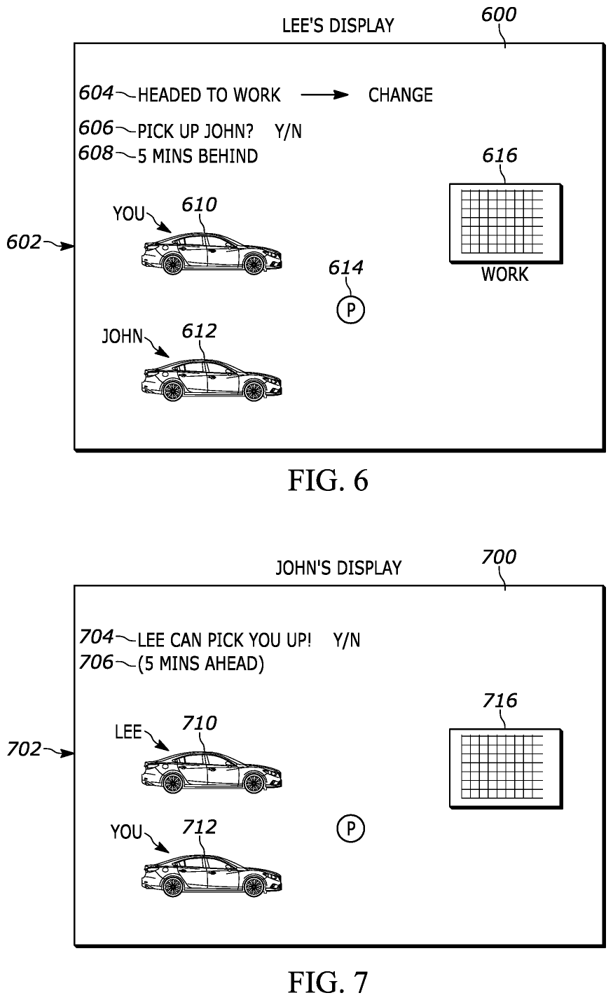

FIGS. 6-9 illustrate further. In these figures, the “user” in FIG. 5 is named “Lee” and a candidate carpooler/friend is named “John”. In FIG. 6 a UI 602 is presented on Lee's display 600 that includes an indication 604 of where Lee is currently going in a vehicle (the user's destination). A selector 606 is presented designating a friend identified according to the example logic of FIG. 5 that may be selected to agree to give john a ride. An indication 608 may be presented indicating how far away John is in miles or time so that Lee can decide if it's worth waiting for John.

Furthermore, the UI 602 may include a user avatar 610 indicating a relative location and if desired direction of travel of Lee's vehicle along with a friend avatar 612 indicating a relative location and direction of travel of John's vehicle. An indication 614 of a carpool parking lot and its location may be presented at which John can meet Lee and jump into Lee's car to carpool. A graphical indication 616 may be presented representing the destination and its relative location.

FIG. 7 illustrates a UI 702 that may be presented in candidate carpooler/friend John's display 700. An indication 704 may be presented notifying John that user Lee can pick John up to carpool, along with an advisory 706 of Lee's proximity to John. As was the case with Lee's UI 602, John's UI 702 may include a user avatar 710 indicating a relative location and if desired direction of travel of Lee's vehicle along with a friend avatar 712 indicating a relative location and direction of travel of John's vehicle. An indication 714 of a carpool parking lot and its location may be presented at which John can meet Lee and jump into Lee's car to carpool. A graphical indication 716 may be presented representing the destination and its relative location.

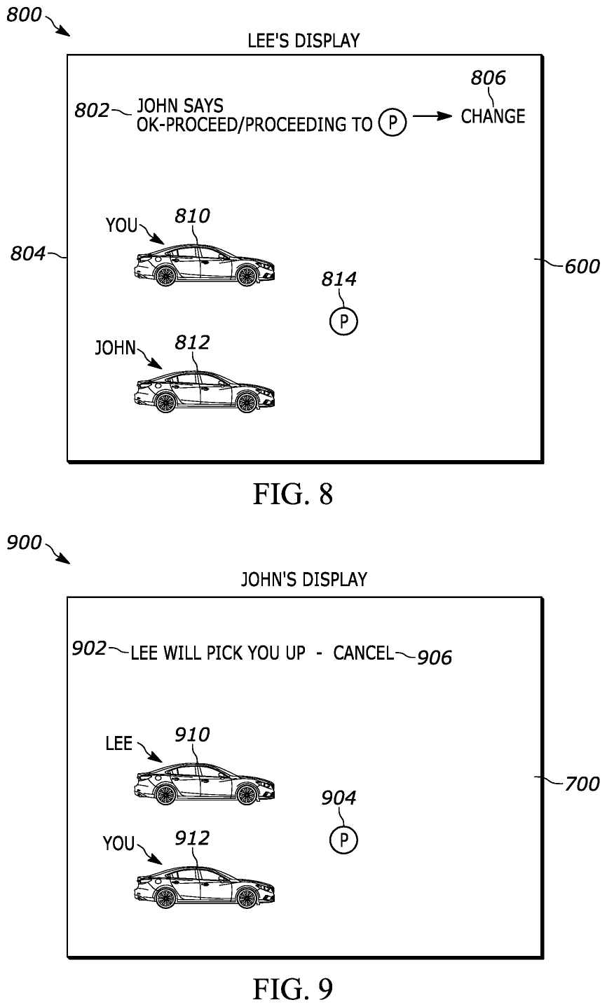

FIGS. 8 and 9 illustrate further UIs 800, 900 that may be respectively presented on Lee and John's respective displays 600, 700. An indication 802 may be presented on Lee's display indicating that John has agreed to carpool, along with an indication 804 that Lee's vehicle is proceeding toward a carpool parking area. A selector 806 may be presented to allow user Lee to change the rendezvous from the parking area indicated at 804 to another location. Furthermore, the UI 800 may include a user avatar 810 indicating a relative location and if desired direction of travel of Lee's vehicle along with a friend avatar 812 indicating a relative location and direction of travel of John's vehicle. An indication 814 of a carpool parking lot and its location may be presented at which John can meet Lee and jump into Lee's car to carpool.

The UI 900 presented on carpooler/friend John's display may include an advisory 902 that user Lee will pick John up at the location 904 of a carpool parking lot or other rendezvous location. A selector 906 may be presented allowing John to send a cancel message to Lee's device. As was the case with Lee's UI 800, John's UI 900 may include a user avatar 910 indicating a relative location and if desired direction of travel of Lee's vehicle along with a friend avatar 912 indicating a relative location and direction of travel of John's vehicle.

It will be appreciated that whilst present principals have been described with reference to some example embodiments, these are not intended to be limiting, and that various alternative arrangements may be used to implement the subject matter claimed herein.

What is claimed is:

1. An apparatus comprising:
at least one processor configured with instructions to:
identify a destination of a user;
access a friends list of the user;
identify at least a first friend in the friends list as a carpool candidate; and
output on at least one display an indication that the first friend is a carpool candidate.

2. The apparatus of claim 1, wherein the instructions are executable to:
output on the display a graphical representation of a location of the first friend.

3. The apparatus of claim 1, wherein the instructions are executable to:
output on the display a graphical representation of parking area at which a carpool can park.

4. The apparatus of claim 1, wherein the instructions are executable to:
output on the display a selector selectable to send a message to the first friend indicating the user can pick up the first friend.

5. The apparatus of claim 3, wherein the instructions are executable to:
output on the display a selector selectable to cause a vehicle to drive to the parking area.

6. The apparatus of claim 1, wherein the instructions are executable to:
identify the first friend as a carpool candidate at least in part based on a distance between the first friend and the user.

7. The apparatus of claim 1, wherein the instructions are executable to:
identify the first friend as a carpool candidate at least in part based on identifying a destination of the first friend as being within a threshold distance of the destination of the user.

8. The apparatus of claim 1, wherein the instructions are executable to:
responsive to identifying the first friend, automatically cause a self-driving vehicle to divert from the destination of the user to a location associated with the first friend.

9. The apparatus of claim 1, wherein the processor is mounted on a vehicle.

10. A method, comprising:
accessing information pertaining to candidate carpoolers;
accessing information pertaining to a destination of a vehicle; and
sending messages to candidate carpoolers based on the destination.

11. The method of claim 10, wherein the information pertaining to candidate carpoolers is accessed from at least one social network.

12. The method of claim 10, wherein the information pertaining to candidate carpoolers comprises locations of the candidate carpoolers.

13. The method of claim 12, wherein the method comprises sending the messages only to candidate carpoolers within a first distance of the vehicle.

14. The method of claim 12, wherein the method comprises sending the messages only to candidate carpoolers having destinations at or near the destination of the vehicle.

15. An assembly comprising:
at least one vehicle;
at least one processor configured with instructions to:
identify a destination of a user; and
transmit to at least a first carpool candidate a message inviting the carpool candidate to ride in the vehicle toward the destination.

16. The assembly of claim 15, wherein the instructions are executable to:
output on at least one display an indication that the first carpool candidate is a carpool candidate.

17. The assembly of claim 15, wherein the instructions are executable to:
output on a display a graphical representation of a location of the first carpool candidate.

18. The assembly of claim 15, wherein the instructions are executable to:
output on a display a graphical representation of parking area at which a carpool can park.

19. The assembly of claim 18, wherein the instructions are executable to:
output on a display a selector selectable to cause a vehicle to drive to the parking area.

20. The assembly of claim 15, wherein the instructions are executable to:
identify the first carpool candidate as a carpool candidate at least in part based on identifying a destination of the first carpool candidate as being within a threshold distance of the destination of the vehicle.
